(19) United States
(12) Patent Application Publication
(10) Pub. No.: US 2019/0385560 A1
(43) Pub. Date: Dec. 19, 2019

(54) DISPLAY APPARATUS AND POWER SAVING METHOD THEREFOR

(71) Applicants: HKC Corporation Limited, Shenzhen City, Guangdong (CN); Chongqing HKC Optoelectronics Technology Co., Limited, Chongqing (CN)

(72) Inventor: Mingliang WANG, Chongqing (CN)

(21) Appl. No.: 15/550,550

(22) PCT Filed: May 31, 2017
(86) PCT No.: PCT/CN2017/086644

§ 371 Date: Aug. 11, 2017

(30) Foreign Application Priority Data
May 12, 2017 (CN) 201710335549.X

(51) Int. Cl. G09G 3/36

(52) U.S. Cl. CPC G09G 3/3688; G09G 3/3677; G09G 2310/0243; G09G 2310/0291; G09G 2330/023

(57) ABSTRACT

This application discloses a display apparatus and a power saving method therefore. The display apparatus includes: a display panel; a plurality of data driver chips, electrically connected to the display panel; a plurality of gate driver chips, electrically connected to the display panel; a power supply chip, electrically connected to the data driver chips and the gate driver chips separately, to control a power supply for the data driver chips and the gate driver chips; a display data detection unit, configured to detect the data driver chips to generate a control signal; and a sequence controller, electrically connected to the data driver chips, the gate driver chips, the power supply chip, and the display data detection unit separately, to control operations of the data driver chips, the gate driver chips, the power supply chip, and the display data detection unit. The sequence controller receives a control signal of the display data detection unit, and in this case, the sequence controller controls, according to the control signal, whether the data driver chips, the gate driver chips, and the power supply chip enter a power saving mode. The power saving mode means reducing from a normal voltage to a preset updated voltage.

### BACKGROUND

### Technical Field

This application relates to a power saving method, and in particular, to a display apparatus and a power saving method therefore.

### Related Art

Liquid crystal displays (LCDs) have been widely used recently. With improvement of driving technologies, LCDs are enabled to possess advantages, such as low consumption power, slimness and a light weight, and low-voltage driving, and currently, have been widely applied to camcorders, notebook computers, desktop displays, and various projection apparatuses.

In addition, a liquid crystal display apparatus usually includes a gate driver circuit, a source driver circuit, and a pixel array. There is a plurality of pixel circuits in the pixel array. Each pixel circuit is turned on and off according to a scanning signal provided by the gate driver circuit, and displays a data image according to a data signal provided by the source driver circuit.

Currently, a resources and environmental protection idea has won support among people. How to reduce power consumption of a liquid crystal panel is also a problem that people strive to resolve. However, in a current driver architecture, when a data driver chip charges a liquid crystal panel, a power supply is provided externally and has a fixed voltage level, leading to relatively high power consumption of the data driver chip. Consequently, not only electric energy is wasted, but also a temperature of the data driver chip is excessively high, and a reliability problem may also be caused. Therefore, to alleviate technical disadvantages in a process of charging a liquid crystal panel by using the foregoing conventional data driver chip, a dynamic power saving method, in which manufacturing costs are low, and processing is easy, is provided.

### SUMMARY

To resolve the foregoing technical problem, an objective of this application is to provide a display apparatus and a power saving method therefore. A power supply of a data driver chip is dynamically switched by detecting display data, so as to dynamically save power. Moreover, a temperature of the data driver chip can be reduced. Therefore, reliability and a service life of a product are improved.

The following technical solutions are used to achieve the objective of this application and to resolve the technical problem of this application. A display apparatus provided according to this application comprises: a display panel; a plurality of data driver chips, electrically connected to the display panel; a plurality of gate driver chips, electrically connected to the display panel; a power supply chip, electrically connected to the data driver chips and the gate driver chips separately, to control a power supply for the data driver chips and the gate driver chips; a display data detection unit, configured to detect the data driver chips to generate a control signal; and a sequence controller, electrically connected to the data driver chips, the gate driver chips, the power supply chip, and the display data detection unit separately, to control operations of the data driver chips, the gate driver chips, the power supply chip, and the display data detection unit. The sequence controller receives a control signal of the display data detection unit, and the sequence controller controls, according to the control signal, whether the data driver chips, the gate driver chips, and the power supply chip enter a power saving mode. The power saving mode means reducing from a normal voltage to a preset updated voltage. The sequence controller generates a control signal and display data, the control signal and the display data are transmitted to the data driver chips and the gate driver chips by using a flexible connection flat cable and a printed circuit board, and the data driver chips and the gate driver chips are driven by the control signal to transmit the display data to the display panel.

Another objective of this application is to provide a power saving method for a display apparatus, comprising: receiving, by using a sequence controller, a control signal detected by a display data detection unit; performing comparison on the control signal by using the sequence controller, to obtain a control signal comparison result; and determining and controlling, according to the control signal comparison result, whether a plurality of driver circuit assemblies enters a power saving mode, where the driver circuit assemblies comprise a plurality of data driver chips, a plurality of gate driver chips, and a power supply chip, and the power saving mode means reducing from a normal voltage to a preset updated voltage.

The technical problem of this application may be further resolved by using the following technical measures.

In an embodiment of this application, the data driver chip comprises a logic control module and an output power amplification module.

In an embodiment of this application, the output power amplification module comprises an amplifier and a complementary switch assembly pair.

In an embodiment of this application, the complementary switch assembly pair comprises an input end, configured to receive a control signal of the display data detection unit, and the complementary switch assembly pair generates a first signal pulse according to the control signal.

In an embodiment of this application, the complementary switch assembly pair comprises: a first switch, where a control end of the first switch is electrically coupled to an amplifier, a first end of the first switch is electrically coupled to a first operating potential, and a second end of the first switch is electrically coupled to an output pulse signal; a second switch, where a control end of the second switch is electrically coupled to an amplifier, a first end of the second switch is electrically coupled to a second operating potential, and a second end of the second switch is electrically coupled to the output pulse signal.

In an embodiment of this application, the display apparatus further comprises a flexible connection flat cable and a printed circuit board, where the flexible connection flat cable is electrically coupled to the printed circuit board, and the other end of the flexible connection flat cable is electrically coupled to the sequence controller.

In an embodiment of this application, in the power saving method, the step of determining and controlling, according to the control signal comparison result, whether a plurality of driver circuit assemblies enters a power saving mode comprises: transferring, by the sequence controller, information of the control signal comparison result to the power supply chip by using an integrated circuit bus, and notifying a voltage regulation status, so as to achieve a dynamic voltage control process.

In an embodiment of this application, in the power saving method, the data driver chip comprises a logic control module and an output power amplification module, and the output power amplification module comprises an amplifier and a complementary switch assembly pair.

In an embodiment of this application, in the power saving method, the complementary switch assembly pair comprises an input end, configured to receive a control signal of the display data detection unit, and the complementary switch assembly pair generates a first signal pulse according to the control signal; and the complementary switch assembly pair comprises: a first switch, where a control end of the first switch is electrically coupled to an amplifier, a first end of the first switch is electrically coupled to a first operating potential, and a second end of the first switch is electrically coupled to an output pulse signal; and a second switch, where a control end of the second switch is electrically coupled to an amplifier, a first end of the second switch is electrically coupled to a second operating potential, and a second end of the second switch is electrically coupled to the output pulse signal.

In this application, a power supply of a data driver chip is dynamically switched by detecting display data, so as to dynamically save power. Moreover, a temperature of the data driver chip can be reduced. Therefore, reliability and a service life of a product are improved.

### BRIEF DESCRIPTION OF THE DRAWINGS

FIG. 1 is a schematic diagram of an exemplary liquid crystal display panel formed from a liquid crystal display pixel array;

FIG. 2 is a schematic diagram of an exemplary equivalent capacitive load, which is related to a liquid crystal display pixel in a liquid crystal display panel, of a related switch assembly;

FIG. 3 is a schematic diagram of another exemplary equivalent capacitive load, which is related to a liquid crystal display pixel in a liquid crystal display panel, of a related switch assembly;

FIG. 4 shows an architecture of an exemplary gate driver circuit;

FIG. 5a is an equivalent circuit diagram of the exemplary gate driver circuit in FIG. 4 when a signal at an input end is at a high level;

FIG. 5b is an equivalent circuit diagram of the exemplary gate driver circuit in FIG. 4 when a signal at an input end is at a low level;

FIG. 6 is a schematic diagram of a display apparatus according to an embodiment of this application;

FIG. 7a is a schematic diagram of a data driver chip according to an embodiment of this application;

FIG. 7b is a schematic diagram of an output power amplification module according to an embodiment of this application; and

FIG. 8 is a schematic diagram of a sequence controller having a display data detection unit according to an embodiment of this application.

### DETAILED DESCRIPTION

The following embodiments are described with reference to the accompanying drawings, which are used to exemplify specific embodiments for implementation of this application. Terms about directions mentioned in this application, such as “on”, “below”, “front”, “back”, “left”, “right”, “in”, “out”, and “side surface” merely refer to directions of the accompanying drawings. Therefore, the used terms about directions are used to describe and understand this application, and are not intended to limit this application.

The accompanying drawings and the description are considered to be essentially exemplary, rather than limitative. In the drawings, units with similar structures are represented by using a same numeral. In addition, for understanding and ease of description, a size and a thickness of each component shown in the accompanying drawings are arbitrarily shown, but this application is not limited thereto.

In the accompanying drawings, for clarity, thicknesses of a layer, a film, a panel, an area, and the like are enlarged. In the accompanying drawings, for understanding and ease of description, thicknesses of some layers and areas are enlarged. It should be understood that when a component, for example, a layer, a film, an area, or a substrate is described as “being located” “on” another component, the component may be directly on the another component, or there is an intermediate component.

In addition, in the specification, unless clearly described as an opposite meaning, a word “include” is understood as including the component but not excluding any other components. In addition, throughout the specification, “on” means that one is located above or below a target component and does not necessarily mean that one is located on the top based on a gravity direction.

To further describe the technical means adopted in this application to achieve the objective of the present invention and effects thereof, specific implementations, structures, features, and effects of a display apparatus and a power saving method therefore that are provided according to this application are described below in detail with reference to the accompanying drawings and preferred embodiments.

A display panel in this application may be, for example, a liquid crystal display panel, and can include an active array (thin film transistor (TFT)) substrate, a color filter (CF) substrate, and a liquid crystal layer that is formed between the two substrates. In an embodiment, the active array (TFT) and the CF in this application may be formed on a same substrate.

In some embodiments, the display panel in this application may be an OLED display panel, a QLED display panel, or another display panel.

In an embodiment, the display panel in this application may be a curved-surface display panel.

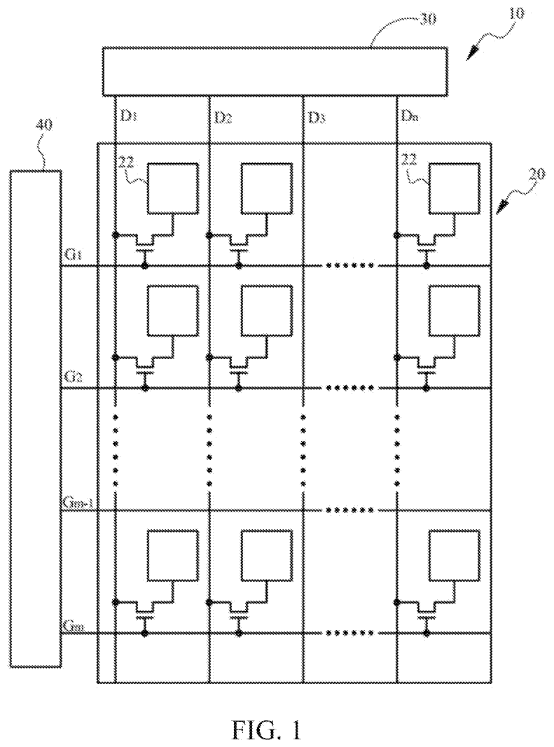

FIG. 1 is a schematic diagram of an exemplary liquid crystal display panel formed from a liquid crystal display pixel array. Referring to FIG. 1, a liquid crystal display panel 10 includes a display module 20 formed from a plurality of pixels 22 arranged in a two-dimensional array. The pixels are controlled and driven by a plurality of data lines D1, D2, . . . , and Dn and a plurality of gate lines G1, G2, . . . , and Gn. A data signal of each data line is provided by a data driver chip 30, and a gate signal of each gate line is provided by a gate driver chip 40.

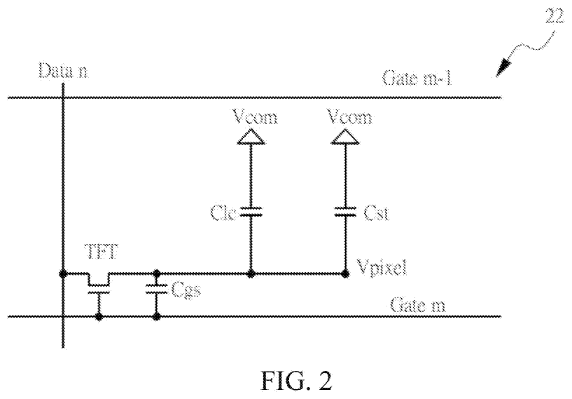

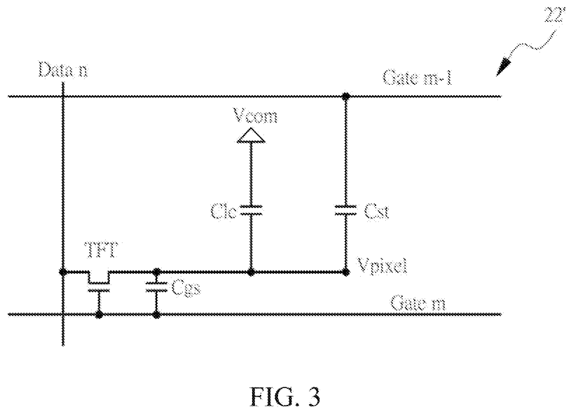

FIG. 2 is a schematic diagram of an exemplary equivalent capacitive load, which is related to a liquid crystal display pixel in a liquid crystal display panel, of a related switch assembly. FIG. 3 is a schematic diagram of another exemplary equivalent capacitive load, which is related to a liquid crystal display pixel in a liquid crystal display panel, of a related switch assembly. Referring to FIG. 2 and FIG. 3, each pixel 22 is related to a plurality of capacitors, such as a capacitor Clc that is formed from a liquid crystal layer capacitor located between an upper layer electrode and a lower layer electrode and that is related to the liquid crystal layer capacitor, an extra charge storage capacitor Cst whose voltage is kept at a Vpixel value after a gate line signal Gate m passes through the extra charge storage capacitor Cst, and a capacitor Cgs related to a gate end and a source end of a switch assembly (an active switch, a TFT). A total capacitance value of pixels of a liquid crystal display panel may change due to a size of a pixel, a thickness of a liquid crystal layer, a size of a storage capacitor, and impacts of several other technologies that are well known to persons skilled in the art. As shown in FIG. 2, Clc and Cgs are both connected to a common voltage Vcom. As shown in FIG. 3, Cst is connected to a gate line.

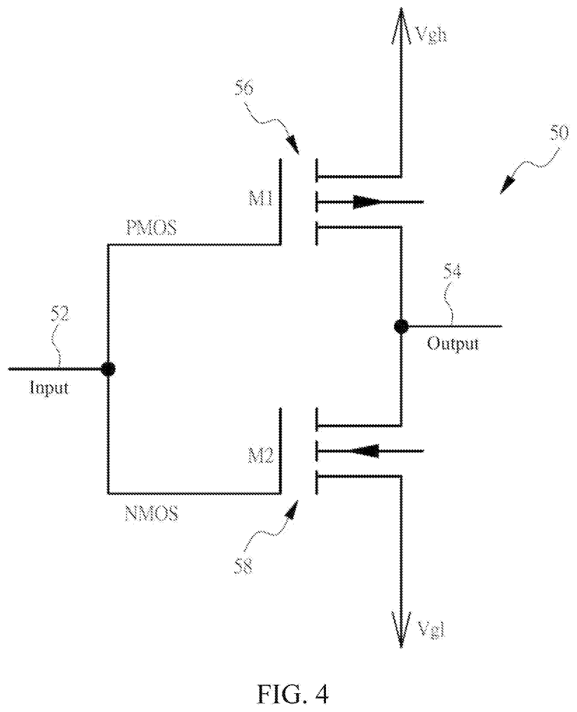

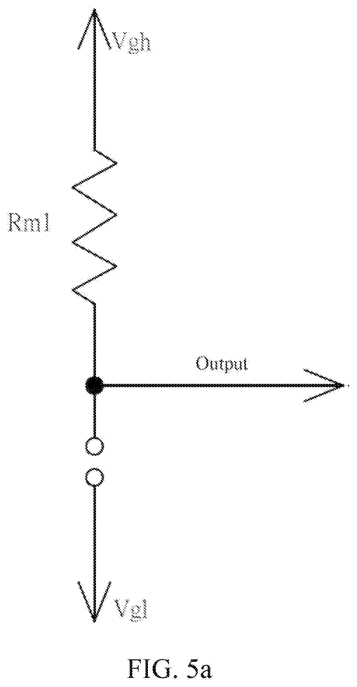

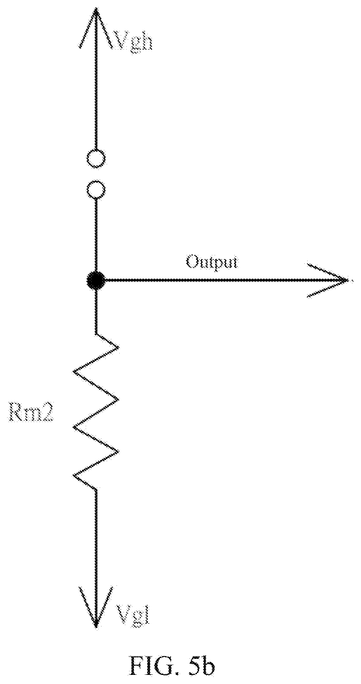

FIG. 4 shows an architecture of an exemplary gate driver circuit. FIG. 5a is an equivalent circuit diagram of the exemplary gate driver circuit in FIG. 4 when a signal at an input end is at a high level. FIG. 5b is an equivalent circuit diagram of the exemplary gate driver circuit in FIG. 4 when a signal at an input end is at a low level. Referring to FIG. 4, FIG. 5a, and FIG. 5b, a circuit 50 is usually configured to provide a gate line signal, so as to drive a row of liquid crystal display pixels. A gate driver circuit 50 usually operates in a rail-to-rail manner between a Vgh level and at a Vgl level, and has a gate input end 52 and an output end 54, so as to drive a gate of a switch assembly (TFT) of a liquid crystal display pixel. The gate driver circuit 50 is formed from a PMOS switch assembly 56 and an NMOS switch assembly 58 in a conventional complementary architecture on a silicon wafer. The gate driver circuit 50 performs operations that are generally known. When a signal of the input end 52 is at a high level, the PMOS switch assembly 56 is conducted due to formation of a P-type channel, and the NMOS switch assembly 58 remains off or not conducted. In this state, a voltage level on the output end 54 is a high level, and an equivalent circuit of the gate driver circuit 50 is shown in FIG. 5a. When the signal of the input end 52 is at a low level, the NMOS switch assembly 58 is conducted due to formation of an N-type channel, and the PMOS switch assembly 56 remains off or not conducted. In this state, a voltage level on the output end 54 is a low level, and an equivalent circuit of the gate driver circuit 50 is shown in FIG. 5b. Rm1 and Rm2 in the figure respectively represent internal impedance of M1 and internal impedance of M2.

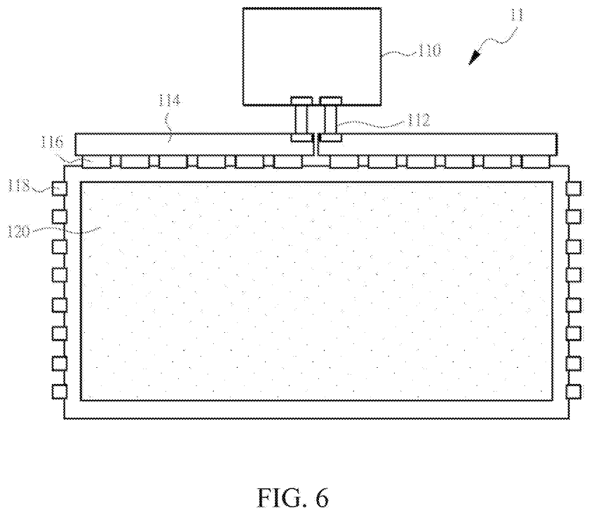

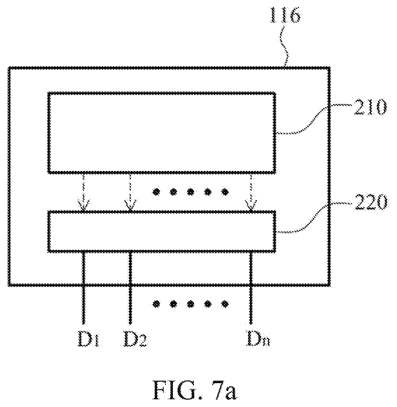

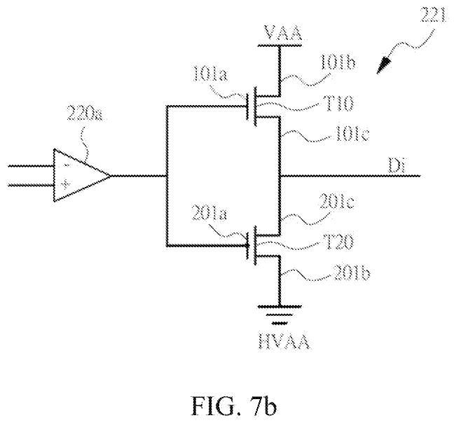

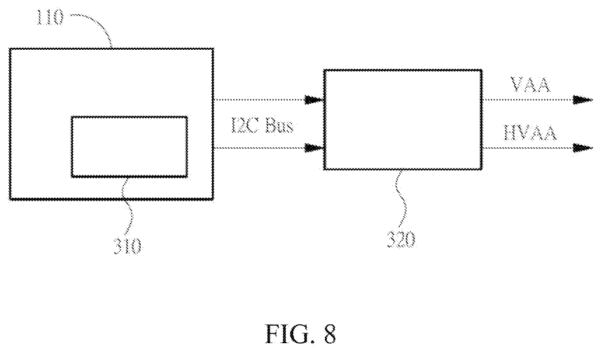

FIG. 6 is a schematic diagram of a display apparatus according to an embodiment of this application. FIG. 7a is a schematic diagram of a data driver chip according to an embodiment of this application. FIG. 7b is a schematic diagram of an output power amplification module according to an embodiment of this application. FIG. 8 is a schematic diagram of a sequence controller having a display data detection unit according to an embodiment of this application. Referring to FIG. 6 and FIG. 8, in an embodiment of this application, a display apparatus 11 includes: a display panel 120; a plurality of data driver chips 116, electrically connected to the display panel 120; a plurality of gate driver chips 118, electrically connected to the display panel 120; a power supply chip 320, electrically connected to the data driver chips 116 and the gate driver chips 118 separately, to control a power supply for the data driver chips 116 and the gate driver chips 118; a display data detection unit 310, configured to detect the data driver chips 116 to generate a control signal; and a sequence controller 110, electrically connected to the data driver chips 116, the gate driver chips 118, the power supply chip 320, and the display data detection unit 310 separately, to control operations of the data driver chips 116, the gate driver chips 118, the power supply chip 320, and the display data detection unit 310. The sequence controller 110 receives a control signal of the display data detection unit 310, and the sequence controller 110 controls, according to the control signal, whether the data driver chips 116, the gate driver chips 118, and the power supply chip 320 enter a power saving mode. The power saving mode means reducing from a normal voltage to a preset updated voltage.

In an embodiment, the display apparatus 11 further includes a flexible connection flat cable 112 and a printed circuit board 114. The flexible connection flat cable 112 is electrically coupled to the printed circuit board 114, and the other end of the flexible connection flat cable 112 is electrically coupled to the sequence controller 110.

In an embodiment, the sequence controller 110 is responsible for generating a control signal and display data, and the control signal and the display data are transmitted to the data driver chips 116 and the gate driver chips 118 by using the flexible connection flat cable 112 and the printed circuit board 114. The driver chips 116 and 118 are driven by the control signal to transmit correct display data to the display panel 120.

Referring to FIG. 7a and FIG. 7b, a driver architecture of a data driver chip 116 is provided. The data driver chip 116 is responsible for charging a liquid crystal unit, and an internal architecture of the data driver chip 116 is generalized as a logic control module 210 and an output power amplification module 220. FIG. 7b is a simplified schematic diagram of one output channel of the output power amplification module 220. The output power amplification module 220 mainly includes an amplifier 220a and a complementary switch assembly pair 221 (CMOS) architecture. When an output level of the amplifier 220a is higher than an original voltage level of the liquid crystal unit, and the amplifier 220a is charged by a VAA by using an upper-end first switch T10 (NMOS). When the output level is lower than the original voltage level of the liquid crystal unit, the liquid crystal unit discharges to an HVAA (1/2 VAA) by using a lower-end second switch T20 (PMOS). In FIG. 7b, a positive charging and discharging unit is used as an example, and a negative charging and discharging unit is similar to the positive charging and discharging unit, and differs from the positive charging and discharging unit only in that power supplies are the HVAA and a GND. Therefore, in an existing driver architecture, the several power supplies have fixed voltage levels. In this case, a VAA-Di voltage difference or a Di-HVAA voltage difference is exerted on the first switch T10 (NMOS) or the second switch T20 (PMOS). Consequently, power consumption is relatively high, and a temperature of the data driver chip 116 is also relatively high.

Referring to FIG. 7b, in an embodiment, the complementary switch assembly pair 221 includes: a first switch T10, where a control end 101a of the first switch T10 is electrically coupled to an amplifier 220a, a first end 101b of the first switch T10 is electrically coupled to a first operating potential VAA, and a second end 101c of the first switch T10 is electrically coupled to an output pulse signal Di; a second switch T20, where a control end 201a of the second switch T20 is electrically coupled to an amplifier 220a, a first end 201b of the second switch T20 is electrically coupled to a second operating potential HVAA, and a second end 201c of the second switch T20 is electrically coupled to the output pulse signal Di.

Referring to FIG. 7b and FIG. 8, in an embodiment, the complementary switch assembly pair 221 includes an input end, configured to receive a control signal of the display data detection unit 310, and the complementary switch assembly pair 221 generates a first signal pulse according to the control signal.

Referring to FIG. 7b and FIG. 8, in an embodiment of this application, a display data detection unit 310 is added into the sequence controller 110, to detect a status of a current column data bit. Using current 8-bit processing as an example, when it is detected that last 4 bits in a current column of display data are all 0, for example, XXXX0000 (X is 0 or 1), it is considered that only an upper half of a positive voltage is output at this moment, so that a lower-end voltage HVAA of the second switch T20 (PMOS) may be regulated to 3/4 VAA. In this case, for a liquid crystal unit whose voltage in a previous frame is higher than 3/4 VAA, a discharging voltage difference changes from Di-HVAA to Di-3/4VAA, and a voltage difference becomes small. Therefore, power consumed by the second switch T20 (PMOS) becomes small, and a temperature is reduced while power is saved. Similarly, a negative power supply is also switched in this manner. Moreover, for adding a display data detection unit 310, in the existing sequence controller 110, because data in a previous frame and in a current frame has already been detected due to over drive, no great change would be caused even if a display data detection unit 310 is added.

Referring to FIG. 6, FIG. 7a, FIG. 7b, and FIG. 8, in an embodiment of this application, a power saving method for a display apparatus 11 includes: receiving, by using a sequence controller 110, a control signal detected by a display data detection unit 310; performing comparison on the control signal by using the sequence controller 110, to obtain a control signal comparison result; and determining and controlling, according to the control signal comparison result, whether a plurality of driver circuit assemblies enters a power saving mode, where the driver circuit assemblies include a plurality of data driver chips 116, a plurality of gate driver chips 118, and a power supply chip 320, and the power saving mode means reducing from a normal voltage to a preset updated voltage.

In an embodiment, in the power saving method, the step of determining and controlling, according to the control signal comparison result, whether a plurality of driver circuit assemblies enters a power saving mode includes: transferring, by the sequence controller 110, information of the control signal comparison result to the power supply chip 320 by using an integrated circuit bus I2C Bus, and notifying a voltage regulation status, so as to achieve a dynamic voltage control process.

In an embodiment, in the power saving method, the data driver chip 116 includes a logic control module 210 and an output power amplification module 220, and the output power amplification module 220 includes an amplifier 220a and a complementary switch assembly pair 221.

In an embodiment, in the power saving method, the complementary switch assembly pair 221 includes an input end, configured to receive a control signal of the display data detection unit 310, and the complementary switch assembly pair 221 generates a first signal pulse according to the control signal; and the complementary switch assembly pair 221 includes: a first switch T10, where a control end 101a of the first switch T10 is electrically coupled to an amplifier 220a, a first end 101b of the first switch T10 is electrically coupled to a first operating potential VAA, and a second end 101c of the first switch T10 is electrically coupled to an output pulse signal Di; and a second switch T20, where a control end 201a of the second switch T20 is electrically coupled to an amplifier 220a, a first end 201b of the second switch T20 is electrically coupled to a second operating potential HVAA, and a second end 201c of the second switch T20 is electrically coupled to the output pulse signal Di.

In this application, a power supply of a data driver chip is dynamically switched by detecting display data, so as to dynamically save power. Moreover, a temperature of the data driver chip can be reduced. Therefore, reliability and a service life of a product are improved.

Terms, such as “in some embodiments” and “in various embodiments”, are repeatedly used. The terms usually not refer to a same embodiment, but they may refer to a same embodiment. Words, such as “comprise”, “have”, and “include”, are synonyms, unless other meanings are indicated in the context of the words.

The foregoing descriptions are merely preferred embodiments of this application, and are not intended to limit this application in any form. Although this application has been disclosed above through the preferred embodiments, the embodiments are not intended to limit this application. Any person skilled in the art can make some equivalent variations or modifications according to the foregoing disclosed technical content without departing from the scope of the technical solutions of this application to obtain equivalent embodiments. Any simple amendment, equivalent change or modification made to the foregoing embodiments according to the technical essence of this application without departing from the content of the technical solutions of this application shall fall within the scope of the technical solutions of this application.

What is claimed is:

1. A display apparatus, comprising:
a display panel;
a plurality of data driver chips, electrically connected to the display panel;
a plurality of gate driver chips, electrically connected to the display panel;
a power supply chip, electrically connected to the data driver chips and the gate driver chips separately, to control a power supply for the data driver chips and the gate driver chips;
a display data detection unit, configured to detect the data driver chips to generate a control signal; and
a sequence controller, electrically connected to the data driver chips, the gate driver chips, the power supply chip, and the display data detection unit separately, to control operations of the data driver chips, the gate driver chips, the power supply chip, and the display data detection unit, wherein the sequence controller receives a control signal of the display data detection unit, and the sequence controller controls, according to the control signal, whether the data driver chips, the gate driver chips, and the power supply chip enter a power saving mode, and the power saving mode means reducing from a normal voltage to a preset updated voltage.

2. The display apparatus according to claim 1, wherein the data driver chip comprises a logic control module and an output power amplification module.

3. The display apparatus according to claim 2, wherein the output power amplification module comprises an amplifier and a complementary switch assembly pair.

4. The display apparatus according to claim 3, wherein the complementary switch assembly pair comprises an input end, configured to receive a control signal of the display data detection unit, and the complementary switch assembly pair generates a first signal pulse according to the control signal.

5. The display apparatus according to claim 3, wherein the complementary switch assembly pair comprises a first switch, wherein a control end of the first switch is electrically coupled to an amplifier, a first end of the first switch is electrically coupled to a first operating potential, and a second end of the first switch is electrically coupled to an output pulse signal.

6. The display apparatus according to claim 5, wherein the complementary switch assembly pair comprises a second switch, wherein a control end of the second switch is electrically coupled to an amplifier, a first end of the second switch is electrically coupled to a second operating potential, and a second end of the second switch is electrically coupled to the output pulse signal.

7. The display apparatus according to claim 1, further comprising a flexible connection flat cable and a printed circuit board, wherein the flexible connection flat cable is electrically coupled to the printed circuit board, and the other end of the flexible connection flat cable is electrically coupled to the sequence controller.

8. A power saving method for a display apparatus, comprising:
receiving, by using a sequence controller, a control signal detected by a display data detection unit;
performing comparison on the control signal by using the sequence controller, to obtain a control signal comparison result; and
determining and controlling, according to the control signal comparison result, whether a plurality of driver circuit assemblies enters a power saving mode, wherein
the driver circuit assemblies comprise a plurality of data driver chips, a plurality of gate driver chips, and a power supply chip, and the power saving mode means reducing from a normal voltage to a preset updated voltage.

9. The power saving method for a display apparatus according to claim 8, wherein the step of determining and controlling, according to the control signal comparison result, whether a plurality of driver circuit assemblies enters a power saving mode comprises:
transferring, by the sequence controller, information of the control signal comparison result to the power supply chip by using an integrated circuit bus, and notifying a voltage regulation status, so as to achieve a dynamic voltage control process.

10. The power saving method for a display apparatus according to claim 8, wherein the data driver chip comprises a logic control module and an output power amplification module, and the output power amplification module comprises an amplifier and a complementary switch assembly pair.

11. The power saving method for a display apparatus according to claim 10, wherein the complementary switch assembly pair comprises an input end, configured to receive a control signal of the display data detection unit, and the complementary switch assembly pair generates a first signal pulse according to the control signal.

12. The power saving method for a display apparatus according to claim 10, wherein the complementary switch assembly pair comprises a first switch, wherein a control end of the first switch is electrically coupled to an amplifier, a first end of the first switch is electrically coupled to a first operating potential, and a second end of the first switch is electrically coupled to an output pulse signal.

13. The power saving method for a display apparatus according to claim 12, wherein the complementary switch assembly pair comprises a second switch, wherein a control end of the second switch is electrically coupled to an amplifier, a first end of the second switch is electrically coupled to a second operating potential, and a second end of the second switch is electrically coupled to the output pulse signal.

14. A display apparatus, comprising:
a display panel;
a plurality of data driver chips, electrically connected to the display panel;
a plurality of gate driver chips, electrically connected to the display panel;
a power supply chip, electrically connected to the data driver chips and the gate driver chips separately, to control a power supply for the data driver chips and the gate driver chips;
a display data detection unit, configured to detect the data driver chips to generate a control signal; and
a sequence controller, electrically connected to the data driver chips, the gate driver chips, the power supply chip, and the display data detection unit separately, to control operations of the data driver chips, the gate driver chips, the power supply chip, and the display data detection unit, wherein the sequence controller receives a control signal of the display data detection unit, and the sequence controller controls, according to the control signal, whether the data driver chips, the gate driver chips, and the power supply chip enter a power saving mode, and the power saving mode means reducing from a normal voltage to a preset updated voltage, wherein
the sequence controller generates a control signal and display data, the control signal and the display data are transmitted to the data driver chips and the gate driver chips by using a flexible connection flat cable and a printed circuit board, and the data driver chips and the gate driver chips are driven by the control signal to transmit the display data to the display panel.
